(19) United States
(12) Patent Application Publication
(10) Pub. No.: US 2012/0095802 A1
(43) Pub. Date: Apr. 19, 2012

(54) SYSTEM AND METHODS FOR EVALUATING POLITICAL, SOCIAL, AND ECONOMIC RISK ASSOCIATED WITH A GEOGRAPHIC REGION

(75) Inventors: Augustus Van Cortlandt Wilberding, Marietta, GA (US); Charles Allen Bush, Powder Springs, GA (US)

(73) Assignee: THE COCA-COLA COMPANY, Atlanta, GA (US)

(21) Appl. No.: 12/906,702

(22) Filed: Oct. 18, 2010

(51) Int. Cl. G06Q 10/00

(52) U.S. Cl. 705/7.28

(57) ABSTRACT

Embodiments of the invention relate to systems and methods for evaluating political, social, and economic risk associated with a geographic region. In one embodiment, a system for evaluating political, social, and economic risk associated with a geographic region can be provided. The system can include an output device and a computer processor operable to execute computer readable instructions embodied in a data collection module and a risk modeling engine. The data collection module can be operable to: receive a plurality of indexes or scores associated with the geographic region, wherein one or more received indexes or scores are weighted with predefined coefficients; and aggregate the received indexes or scores. The risk modeling engine can be operable to generate at least one quantitative indicator based at least in part on the aggregated indexes or scores; and output a risk level indicator to the output device based at least in part on comparing the at least one quantitative indicator to one or more predefined risk level thresholds.

### TECHNICAL FIELD

The invention relates generally to risk management systems and processes, and more particularly to systems and methods for evaluating political, social, and economic risk associated with a geographic region.

### BACKGROUND OF THE INVENTION

Companies conducting business in global markets can be exposed to different risks in different countries. For example, political instability in a country can pose a significant risk to a company operating in the particular country. Multiple countries with political instability can heighten the risk to a company operating in those countries. Such risk can impact a company's short term and long term interests. For instance, a company's strategy, supply chain, and profitability can be affected by such risk.

Measuring and tracking the risk associated with any particular country can be a time consuming and difficult task given all of the different factors that can affect risk associated with each country. These factors can include, but are not limited to, political instability, military coups, expanding insurgencies, war, terrorism, labor activism, sudden economic decline, and public outrage over a rigged election.

One conventional approach to measuring and tracking risk includes hiring a large number of country experts to provide an opinion or view of the political risk in any number of countries. This approach may be a relatively expensive approach due to the numbers of experts involved and may be based on qualitative factors or subjective opinions.

Another conventional approach to measuring and tracking risk includes tracking risks but only in a limited number of countries. This narrow approach may be unsuitable or may otherwise have limited utility for a company or entity operating in additional countries.

Other conventional approaches may track risk for a limited period of time, such as a period of past years. This narrow approach may be unsuitable or otherwise may have limited utility for a company or entity with current and ongoing operations.

A need exists for systems and methods for evaluating political, social, and economic risk associated with a geographic region.

### SUMMARY OF THE INVENTION

Embodiments of the invention can provide some or all of the above needs. Certain embodiments of the invention can provide systems and methods for evaluating political, social, and economic risk associated with a geographic region. In one embodiment, a system for evaluating political, social, and economic risk associated with a geographic region can be provided. The system can include a computer processor operable to execute computer readable instructions embodied in a data collection module and a risk modeling engine; and an output device. The data collection module can be operable to: receive a plurality of indexes or scores associated with the geographic region from one or more of the following: a political rights index, a civil liberties index, a human development index, a corruption perceptions index, a political security score, a rule of law score, a government effectiveness score, or a global competitiveness index; standardize the received indexes or scores, wherein one or more received indexes or scores are weighted with predefined coefficients; and aggregate the received indexes or scores. The risk modeling engine can be operable to generate at least one quantitative indicator based at least in part on the aggregated indexes or scores; and output a risk level indicator to the output device based at least in part on comparing the at least one quantitative indicator to one or more predefined risk level thresholds.

In one aspect of an embodiment, the data collection module can be further operable to: receive historical data associated with the geographic region; and adjust the received indexes or scores or the at least one quantitative indicator based at least in part on the received historical data.

In one aspect of an embodiment, the risk modeling engine is further operable to: generate a risk trend for a plurality of predefined times based at least in part on the aggregated indexes or scores, the system further comprising: a decision output module operable to: generate one or more qualitative indicators or risk level indicators for the plurality of predefined times.

In one aspect of an embodiment, the risk modeling engine is further operable to: output a confidence level based at least in part on the plurality of indexes or scores for the geographic region, and further based at least in part on historical data associated with the geographic region.

In one aspect of an embodiment, the system can further include a decision output module operable to: output a comparison to the output device of one or more qualitative indicators or risk level indicators generated for a plurality of geographic regions.

In one aspect of an embodiment, the system can further include a decision control module operable to: based at least in part on the at least one qualitative indicator or risk level indicator for the geographic region, generate a recommendation for at least one of the following: an investment associated with the geographic region, a product or service delivery associated with the geographic region, an inventory change associated with the geographic region, a personnel change associated with the geographic region, or a change in management associated with the geographic region.

In one aspect of an embodiment, the system can further include a decision control module operable to: based at least in part on the at least one qualitative indicator or risk level indicator for the geographic region, implement a control action for at least one of the following: an investment associated with the geographic region, a product or service delivery associated with the geographic region, an inventory change associated with the geographic region, a personnel change associated with the geographic region, or a change in management associated with the geographic region.

In one aspect of an embodiment, some or all of the received indexes or scores are subjected to principal component analysis.

In one aspect of an embodiment, the risk modeling engine is further operable to: output an indication of a type of risk that influences the at least one quantitative indicator.

In another embodiment, a computer program product can be provided. The computer program product can include a computer readable medium having computer readable program code, wherein the computer readable program can be operable to be executed to implement a method for evaluating political, social, and economic risk associated with a geographic region. The method can include providing a system, wherein the system comprises software modules, wherein the software modules comprise a data collection module and a risk modeling engine; receiving, by the data collection module, a plurality of indexes or scores associated with the geographic region from one or more of the following: a political rights index, a civil liberties index, a human development index, a corruption perceptions index, a political security score, a rule of law score, a government effectiveness score, or a global competitiveness index; standardizing, by the data collection module, the received indexes or scores, wherein one or more received indexes or scores are weighted with predefined coefficients; aggregating, by the data collection module, the received indexes or scores; generating, by the risk modeling engine, at least one quantitative indicator based at least in part on the aggregated indexes or scores; and outputting, by the risk modeling engine, a risk level indicator based at least in part on comparing the at least one quantitative indicator to one or more predefined risk level thresholds.

In one aspect of an embodiment, the method can further include receiving, by the data collection module, historical data associated with the geographic region; and adjusting, by the data collection module, the received indexes or scores, or by the risk modeling engine, the at least one quantitative indicator based at least in part on the received historical data.

In one aspect of an embodiment, the method can further include generating, by the risk modeling engine, a risk trend for a plurality of predefined times based at least in part on the aggregated indexes or scores, and wherein the software modules can further include a decision output module, and the method can further include generating, by the decision output module, one or more qualitative indicators or risk level indicators for the plurality of predefined times.

In one aspect of an embodiment, the method can further include outputting, by the risk modeling engine, a confidence level based at least in part on the plurality of indexes or scores for the geographic region, and further based at least in part on historical data associated with the geographic region.

In one aspect of an embodiment, the software modules can further include a decision output module, and the method can further include outputting, by the decision output module, a comparison of one or more qualitative indicators or risk level indicators generated for a plurality of geographic regions.

In one aspect of an embodiment, the software modules can further include a decision control module, and the method can further include based at least in part on the at least one qualitative indicator or risk level indicator for the country, generating, by the decision control module, a recommendation for at least one of the following: an investment associated with the geographic region, a product or service delivery associated with the geographic region, an inventory change associated with the geographic region, a personnel change associated with the geographic region, or a change in management associated with the geographic region.

In one aspect of an embodiment, the software modules can further include a decision control module, and the method can further include based at least in part on the at least one qualitative indicator or risk level indicator for the country, implementing, by the decision control module, a control action for at least one of the following: an investment associated with the geographic region, a product or service delivery associated with the geographic region, an inventory change associated with the geographic region, a personnel change associated with the geographic region, or a change in management associated with the geographic region.

In one aspect of an embodiment, some or all of the received indexes or scores are subjected to principal component analysis.

In yet another embodiment, a method for evaluating political, social, and economic risk associated with a geographic region can be provided. The method can include receiving a plurality of indexes or scores associated with the geographic region from one or more of the following: a political rights index, a civil liberties index, a human development index, a corruption perceptions index, a political security score, a rule of law score, a government effectiveness score, or a global competitiveness index; standardizing the received indexes or scores, wherein one or more received indexes or scores are weighted with predefined coefficients; aggregating the received indexes or scores; generating at least one quantitative indicator based at least in part on the aggregated indexes or scores; and outputting a risk level indicator based at least in part on comparing the at least one quantitative indicator to one or more predefined risk level thresholds, wherein the above elements are performed by one or more computer processors.

In one aspect of an embodiment, the method can further include receiving historical data associated with the geographic region; and adjusting the received indexes or scores or the at least one quantitative indicator based at least in part on the received historical data.

In one aspect of an embodiment, the method can further include generating a risk trend for a plurality of predefined times based at least in part on the aggregated indexes or scores; and generating one or more qualitative indicators or risk level indicators for the plurality of predefined times.

In one aspect of an embodiment, the method can further include outputting a confidence level based at least in part on the plurality of indexes or scores for the geographic region, and further based at least in part on historical data associated with the geographic region.

In one aspect of an embodiment, the method can include outputting a comparison of one or more qualitative indicators or risk level indicators generated for a plurality of geographic regions.

In one aspect of an embodiment, the method can include based at least in part on the at least one qualitative indicator or risk level indicator for the country, generating a recommendation for at least one of the following: an investment associated with the geographic region, a product or service delivery, an inventory change, a personnel change, or a change in management.

In one aspect of an embodiment, the method can include based at least in part on the at least one qualitative indicator or risk level indicator for the country, implementing a control action for at least one of the following: an investment associated with the geographic region, a product or service delivery, an inventory change, a personnel change, or a change in management.

In one aspect of an embodiment, some or all of the received indexes or scores are subjected to principal component analysis

Other systems and processes according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIG. 1 illustrates an example functional block diagram of an example system, according to one embodiment of the invention.

FIGS. 2 and 3 illustrate example flowcharts of example methods according to embodiments of the invention.

FIGS. 4-7 illustrate example interfaces provided by systems and methods according to one embodiment of the invention.

### DETAILED DESCRIPTION OF EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

As used herein, the terms “indexes,” and “scores,” can refer to any measure, quantitative or qualitative, that can be compared to another measure.

As used herein, the term “geographic region” can refer to a region, a country, an economic or geopolitical bloc or consortium, a state, a province, a county, a state, a municipality, or a city.

Certain embodiments of the invention generally provide for systems and methods for evaluating political, social, and economic risk associated with a geographic region. Such systems and methods can provide one or more management tools for measuring risk in countries where a company may have or is considering business interests. In one example, a management tool according to one embodiment of the invention can, using quantitative techniques, measure and track political, social, and economic risk on an annual basis in over 200 different countries. In any instance, the use of one or more management tools according to an embodiment of the invention can permit an organization or entity to make and implement decisions regarding investments, product/service delivery, inventories, personnel, and/or management with respect to any country for which risk has been evaluated for using the management tools. In addition, management tools providing quantitative risk measures can provide a benchmark risk level that can be readily understood through the organization or entity. Such risk measures can be applied to strategic planning and/or future-oriented analysis, and could be used for identifying risks to a supply chain, and brand and reputation. Such risk measures can also be applied to focus organizational attention and resources, to understand the development of political, social, and/or economic risk over time in a particular market, and to understand comparative risks between markets. Therefore, certain embodiments can provide technical solutions for transforming risk information and measures for a particular country into a recommendation for and/or control action by an organization or entity with respect to an investment, product/service delivery, inventory, personnel, and/or management in the particular country.

Certain embodiments of the invention have applicability to a variety of industries, companies, organizations, and entities. For example, one embodiment of the invention can be used by a worldwide supplier and marketer of beverages. Other example users or beneficiaries of example embodiments of the invention can include, but are not limited to, agricultural sector suppliers, product manufacturers, packaging and non-food raw material industries, wholesale and retail companies, distribution companies, entertainment and media companies, real estate companies, investment companies, law and accounting firms, professional services firms, management consultants, consultant firms, banks and financial institutions, non-profit organizations, governments and agencies, and any other organization or entity with business interests.

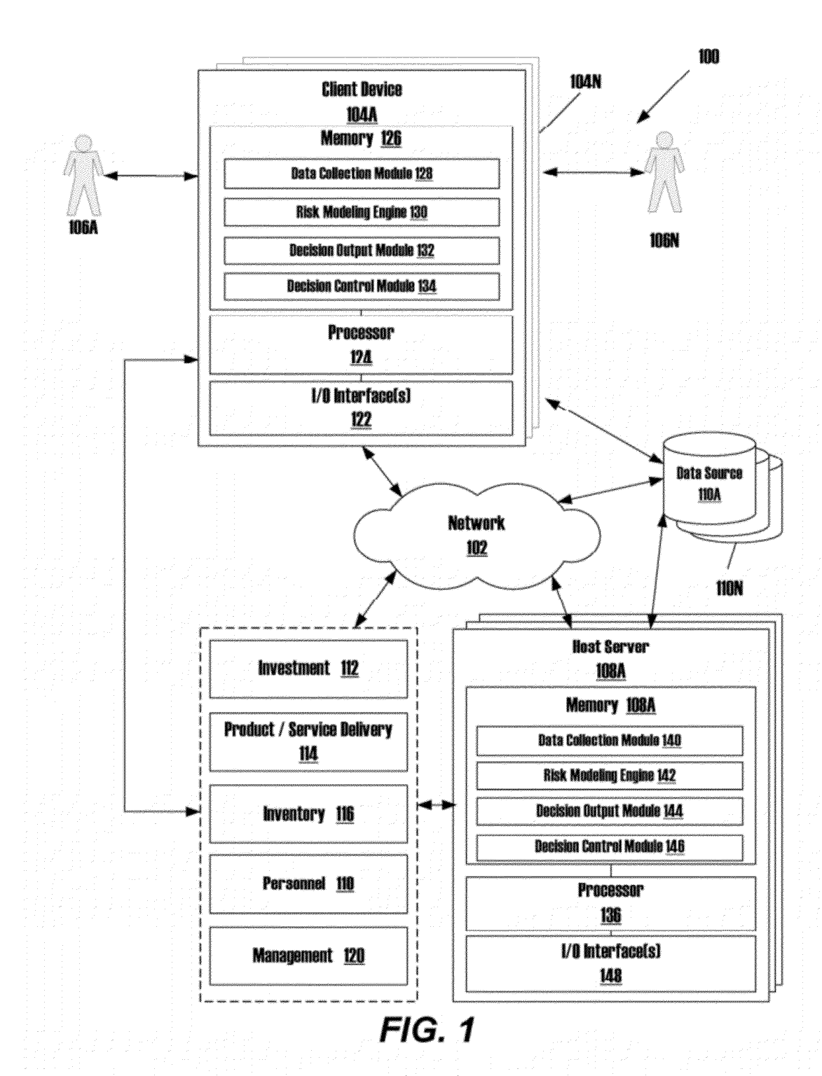

FIG. 1 illustrates an example environment and system in accordance with an embodiment of the invention. In this example, the environment can be a client-server configuration, and the system can be a political, social, and economic risk modeling and control system 100. The system 100 is shown with a communications network 102, such as the Internet, in communication with at least one client device 104A. Any number of other client devices 104N can also be in communication with the network 102. Each of the client devices 104A-104N can be operable to receive information from one or more respective users 106A-106N. The network 102 is also shown in communication with at least one server 108A, such as a website host server. Any number of other servers or website host servers 108N can also be in communication with the network 102. In addition, the network 102 is also shown in communication with at least one data source, such as data source 110A. Any number of other data sources 110N can also be in communication with the network 102. One will appreciate that direct communication links between system components can also implemented in certain embodiments. For example, a client device 104A may be in direct, bi-directional communication with one or more data sources, such as 110A.

Optionally, the network 102 can be in communication with one or more organizational modules and/or control engines, such as an investment module 112, a product/service delivery module 114, an inventory module 116, a personnel module 118, and a management module 120. Each of the organizational modules and/or control engines can be associated with an organization, company, corporation, or other entity. An example organization can be a beverage manufacturer and distributor operating in over 200 countries.

The communications network 102 shown in FIG. 1 can be, for example, the Internet. In another embodiment, the network 102 can be a wireless communications network capable of transmitting both voice and data signals, including image data signals or multimedia signals. Other types of communications networks, including local area networks (LAN), wide area networks (WAN), a public switched telephone network, or combinations thereof can be used in accordance with various embodiments of the invention.

Each client device 104A-104N can be a computer or processor-based device capable of communicating with the communications network 102 via a signal, such as a wireless frequency signal or a direct wired communication signal. A respective communication or input/output interface 122 associated with each client device 104A-104N can facilitate communications between the client device 104A-104N and the network 102 or Internet. Furthermore, the communication or input/output interface 122 can facilitate communications with one or more organizational modules and/or control engines, such as 112, 114, 116, 118, 120, each associated with an organization, company, corporation, or other entity. Each client device, such as 104A, can include a processor 124 and a computer-readable medium, such as a random access memory (RAM) 126, coupled to the processor 124. The processor 124 can execute computer-executable program instructions stored in memory 126. Computer executable program instructions stored in memory 126 can include a data collection module, such as 128, a risk modeling engine, such as 130, a decision output module, such as 132, and a decision control module, such as 134. The one or more modules 128, 132, 134 and/or engine 130 can be adapted to access and/or receive risk data and associated content from at least one remotely located server, such as 108A, and/or data source, such as 110A. In certain instances, the one or more modules 128, 132, 134 and/or engine 130 can be adapted to provide risk data and associated content to one or more organizational modules and/or control engines, such as 112, 114, 116, 118, 120.

Each server 108A-108N can be a computer or processor-based device capable of communicating with the communications network 102 via a signal, such as a wireless frequency signal or a direct wired communication signal. Server 108A, depicted as a single computer system, may be implemented as a network of computer processors. Examples of suitable servers are server devices, mainframe computers, networked computers, a processor-based device, and similar types of systems and devices. The server, such as 108A, can include a processor 136 and a computer-readable medium, such as a random access memory (RAM) 138, coupled to the processor 136. The processor 136 can execute computer-executable program instructions stored in memory 138. Computer executable program instructions stored in memory 138 can include a data collection module, such as 140, a risk modeling engine, such as 142, a decision output module, such as 144, and a decision control module, such as 146. A respective communication or input/output interface 148 associated with each server 108A-108N can facilitate communications between the server 108A-108N and the network 102 or Internet. Furthermore, the communication or input/output interface 148 can facilitate communications with one or more organizational modules and/or control engines, such as 112, 114, 116, 118, 120, each associated with an organization, company, corporation, or other entity.

The investment module 112 can be a computer or processor-based device capable of communicating with the communications network 102 via a signal, such as a wireless frequency signal or a direct wired communication signal. In at least one embodiment, more than one investment module can be in communication with communications network 102 to receive communications from other system components. The investment module 112 can execute computer-executable program instructions stored in an associated memory. In one embodiment, computer executable program instructions stored in memory can be operable to receive risk data or instructions from a decision control module, such as 134 and/or 146, and implement at least one investment control decision with respect to an associated organization. For example, an investment control decision can include, but is not limited to, purchasing or selling an interest in a state-owned or private company, building a manufacturing or distribution facility, increasing or decreasing manufacturing or distribution capacity, maintaining manufacturing or distribution capacity, purchasing or selling a financial instrument, and entering a joint venture with a local company.

The product/service delivery module 114 can be a computer or processor-based device capable of communicating with the communications network 102 via a signal, such as a wireless frequency signal or a direct wired communication signal. In at least one embodiment, more than one product/service delivery module can be in communication with communications network 102 to receive communications from other system components. The product/service delivery module 114 can execute computer-executable program instructions stored in an associated memory. In one embodiment, computer executable program instructions stored in memory can be operable to receive risk data or instructions from a decision control module, such as 134 and/or 146, and implement at least one product/service delivery control decision with respect to an associated organization. For example, a product/service delivery control decision can include, but is not limited to, increasing or decreasing product and/or service delivery, maintaining product and/or service delivery, and diversifying product and/or service delivery.

The inventory module 116 can be a computer or processor-based device capable of communicating with the communications network 102 via a signal, such as a wireless frequency signal or a direct wired communication signal. In at least one embodiment, more than one inventory module can be in communication with communications network 102 to receive communications from other system components. The inventory module 116 can execute computer-executable program instructions stored in an associated memory. In one embodiment, computer executable program instructions stored in memory can be operable to receive risk data or instructions from a decision control module, such as 134 and/or 146, and implement at least one inventory control decision with respect to an associated organization. For example, an inventory control decision can include, but is not limited to, increasing or decreasing product inventory, maintaining product inventory, and diversifying product inventory.

The personnel module 118 can be a computer or processor-based device capable of communicating with the communications network 102 via a signal, such as a wireless frequency signal or a direct wired communication signal. In at least one embodiment, more than one personnel module can be in communication with communications network 102 to receive communications from other system components. The personnel module 118 can execute computer-executable program instructions stored in an associated memory. In one embodiment, computer executable program instructions stored in memory can be operable to receive risk data or instructions from a decision control module, such as 134 and/or 146, and implement at least one personnel control decision with respect to an associated organization. For example, a personnel control decision can include, but is not limited to, increasing or decreasing personnel number, maintaining personnel number, and diversifying personnel hiring.

The management module 120 can be a computer or processor-based device capable of communicating with the communications network 102 via a signal, such as a wireless frequency signal or a direct wired communication signal. In at least one embodiment, more than one management module can be in communication with communications network 102 to receive communications from other system components. The management module 120 can execute computer-executable program instructions stored in an associated memory. In one embodiment, computer executable program instructions stored in memory can be operable to receive risk data or instructions from a decision control module, such as 134 and/or 146, and implement at least one management control decision with respect to an associated organization. For example, a management control decision can include, but is not limited to, increasing or decreasing product and/or service advertising, and maintaining product and/or service advertising.

Each of the data collection modules 128, 140 can be application programs adapted to receive or otherwise collect various risk data from any number of client devices, similar to 104A-104N, and from users 106A-106N, servers 108A-108N, and/or data sources 110A-110N. The data collection modules can process, edit, and store the risk data in one or more files stored in a respective memory 126, 138 or in one or more associated data storage devices, such as a database. In the embodiment shown in FIG. 1, the data collection modules 128, 140 can be operable to receive a plurality of indexes or scores associated with the geographic region from one or more of the following: a political rights index, a civil liberties index, a human development index, a corruption perceptions index, a political security score, a rule of law score, a government effectiveness score, or a global competitiveness index. In other embodiments, other indexes or scores can be received or otherwise obtained by the data collection modules 128, 140. In any instance, the data collection modules 128, 140 can be further operable to standardize the received indexes or scores, wherein one or more received indexes or scores are weighted with predefined coefficients. Furthermore, the data collection modules 128, 140 can be operable to aggregate the received indexes or scores.

In one aspect of an embodiment, the data collection modules 128, 140 can be further operable to receive historical data associated with the geographic region, and adjust the received indexes or scores or the at least one quantitative indicator based at least in part on the received historical data. Historical data can include, but is not limited to, prior indexes or scores associated with the geographic region; information associated with prior political, social, or economic forces or influences associated with the geographic region, or demographic information associated with the geographic region.

Each of the risk modeling engines 130, 142 can be application programs adapted to receive risk data and model risk for any number of geographic regions. The risk modeling engines can process, edit, and store any number of risk modules in one or more files stored in a respective memory 126, 138 or in one or more associated data storage devices, such as a database. In the embodiment shown in FIG. 1, the risk modeling engines 130, 142 can be operable to generate at least one quantitative indicator based at least in part on the aggregated indexes or scores. The risk modeling engines 130, 142 can be further operable to output a risk level indicator to the output device based at least in part on comparing the at least one quantitative indicator to one or more predefined risk level thresholds. For example, a quantitative indicator can be a numerical score between 0-100, also known as a political, social, and economic (PSEC) score; a risk level indicator can be a set of five levels of risk, such as Very Low (VL), Low (L), Medium (M), High (H), and Critical (CR); and predefined risk thresholds can be a series of numerical score ranges corresponding with a risk level indicator, such as 0-20 is “Very Low (VL),” 21-40 is “Low (L),” 41-60 is “Medium (M),” 61-80 is “High (H),” and 81-100 is “Critical (CR).” In certain embodiments, a risk level indicator can be expressed either alone or in combination with a series of corresponding respective colors, such as dark green, light green, yellow, orange, and red. In other embodiments, other quantitative indicators, numerical scores, risk level indicators, colors, predefined risk thresholds, ranges, and cutoffs may be used.

In one aspect of an embodiment, the risk modeling engines 130, 142 can be further operable to generate a risk trend for a plurality of predefined times based at least in part on the aggregated indexes or scores. For example, predefined times can be a range of 5 years including two prior years, the current year, and two subsequent or future years; and a risk trend can be a graphical plot of the indexes or scores against the predefined times. In other embodiments, other ranges of times, such as years, months, or decades may be used.

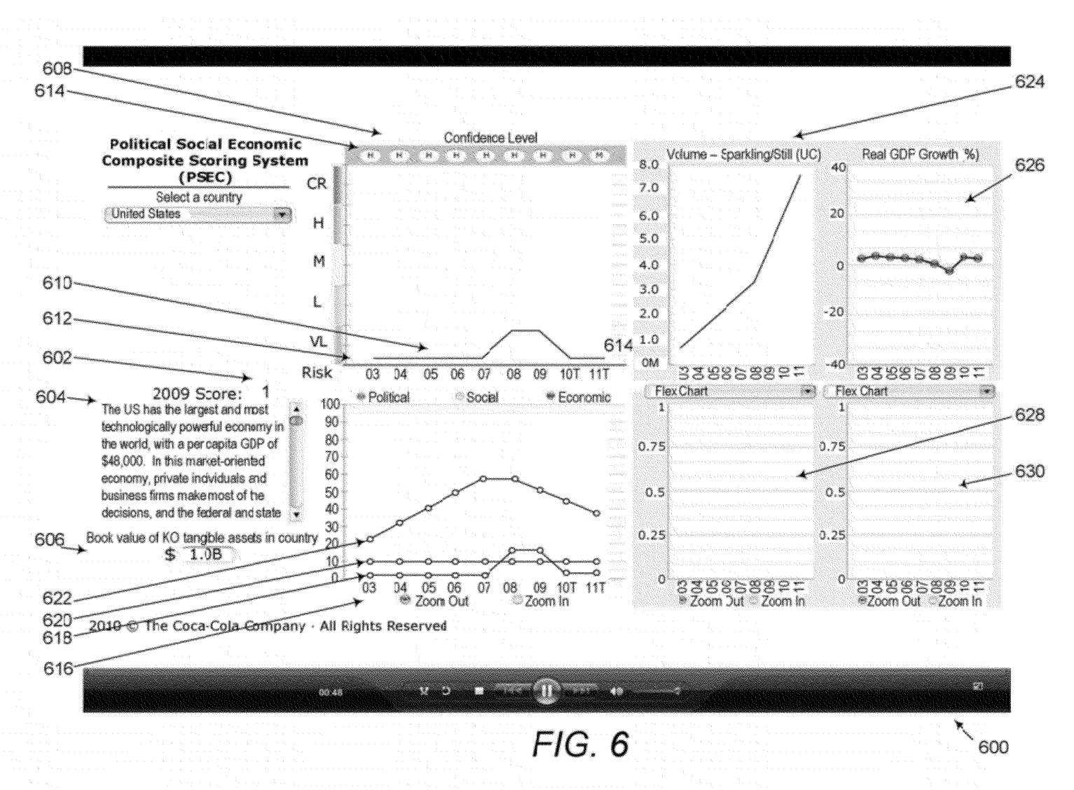

In one aspect of an embodiment, the risk modeling engines 130, 142 can be further operable to output a confidence level based at least in part on the plurality of indexes or scores for the geographic region, and further based at least in part on historical data associated with the geographic region. For example, using one or more statistical or other confidence determining techniques, a confidence level, such as low (L), medium (M), or high (H), can be assigned or otherwise determined for each of the indexes or scores obtained or otherwise received for a geographic region. In another example, the confidence levels can be output with the indexes or scores in an interface, such as 600 described below with respect to FIG. 6. In certain instances, historical data can be used in assigning or otherwise determining a confidence level for each of the indexes or scores.

In one aspect of an embodiment, the risk modeling engines 130, 142 can be further operable to subject or apply principal component analysis to some or all of the received indexes or scores. In other embodiments, the indexes or scores can be subjected to other analyses or transformations.

In one aspect of an embodiment, the risk modeling engines 130, 142 can be further operable to output an indication of a type of risk that influences the at least one quantitative indicator.

Each of the decision output modules 132, 144 can be application programs adapted to generate and output one or more decisions based at least in part on risk data and/or one or more risk models. The decision output modules can process, edit, and store the decisions in one or more files stored in a respective memory 126, 138 or in one or more associated data storage devices, such as a database. In the embodiment shown in FIG. 1, the decision output modules 132, 144 can be operable to generate one or more qualitative indicators or risk level indicators for one or more predefined times. For example, a risk level indicator can be a set of numeric scores between 1 and 5. By way of another example, a qualitative indicator or risk level indicator can be a set of five levels of risk, such as Very Low (VL), Low (L), Medium (M), High (H), and Critical (CR); and predefined times can be a range of 5 years including two prior years, the current year, and two subsequent or future years. In another example, qualitative indicators can be a series of colors, such as dark green, light green, yellow, orange, and red; a series of letters such as A, B, C, D, and F; or a combined series of colors and text. In other embodiments, other ranges of times, such as years, months, or decades may be used. In other embodiments, other qualitative indicators or risk level indicators may be used.

In one aspect of an embodiment, the decision output modules 132, 144 can be further operable to output a comparison to the output device of one or more qualitative indicators or risk level indicators generated for a plurality of geographic regions. For example, a user interface can be provided to display an output comparing one or more countries and the respective qualitative indicators or risk level indicators.

Each of the decision control modules 134, 146 can be application programs adapted to generate and output one or more control actions and/or recommendations based at least in part on risk data and/or one or more risk models. The decision control modules can process, edit, and store the decision controls in one or more files stored in a respective memory 126, 138 or in one or more associated data storage devices, such as a database. In the embodiment shown in FIG. 1, the decision control modules 134, 146 can be operable to generate a recommendation, based at least in part on the at least one qualitative indicator or risk level indicator for the geographic region, for at least one of the following: an investment associated with the geographic region, a product or service delivery associated with the geographic region, an inventory change associated with the geographic region, a personnel change associated with the geographic region, or a change in management associated with the geographic region. For example, a recommendation to increase bottling capacity by 500,000 units by next year in a particular country of interest may be generated by a decision control module, such as 134. Other examples of recommendations can be generated depending on the type of business, scale of business, marketplace, and geographic region.

In at least one aspect of an embodiment, the decision control modules 134, 146 can be further operable to implement a control action, based at least in part on the at least one qualitative indicator or risk level indicator for the geographic region, for at least one of the following: an investment associated with the geographic region, a product or service delivery associated with the geographic region, an inventory change associated with the geographic region, a personnel change associated with the geographic region, or a change in management associated with the geographic region. For example, a control action to authorize US$25 million to increase bottling capacity by 500,000 units within the geographic region of interest can be implemented by a decision control module. Other examples of control actions can be generated depending on the type of business, scale of business, marketplace, and geographic region.

Generally, each of the memories 126, 138 can store data and information for subsequent retrieval. In this manner, the system 100 can store various received or collected risk data or information in memory or a database associated with a client device, such as 104A, or a server, such as 108A. The memories 126, 138 can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, a database can be integrated or distributed into any number of databases or data storage devices.

Suitable processors for the client devices 104A-104N and servers 108A-108N may comprise a microprocessor, an ASIC, and state machine. Example processors can be those provided by Intel Corporation and Motorola Corporation. Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor, such as the processors 124, 136, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Client devices 104A-104N may also comprise a number of other external or internal devices such as a mouse, a CD-ROM, DVD, a keyboard, a display, or other input or output devices. As shown in FIG. 1, a client device such as 104A can be in communication with an output device via a communication or input/output interface, such as 122. Examples of client devices 104A-104N are personal computers, mobile computers, handheld portable computers, digital assistants, personal digital assistants, cellular phones, mobile phones, smart phones, pagers, digital tablets, desktop computers, laptop computers, Internet appliances, and other processor-based devices. In general, a client device, such as 104A, may be any type of processor-based platform that is connected to a network, such as 102, and that interacts with one or more application programs. Client devices 104A-104N may operate on any operating system capable of supporting a browser or browser-enabled application including, but not limited to, Microsoft Windows®, Apple OSX™, and Linux. The client devices 104A-104N shown can include, for example, personal computers executing a browser application program such as Microsoft Corporation's Internet Explorer™, Netscape Communication Corporation's Netscape Navigator™, and Apple's Safari™, and Mozilla Firefox™.

In one embodiment, suitable client devices can be standard desktop personal computers with Intel x86 processor architecture, operating a Microsoft® Windows® operating system, and programmed using a Java language.

A user, such as 106A, can interact with the system 100 via a client device, such as 104A, via any number of input and output devices (not shown) such as an output display device, keyboard, and/or a mouse. In this manner, the user 106A can access one or more interfaces provided by the input/output interface, such as 122, via a client device, such as 104A. In the embodiment shown, a user 106A can input or otherwise access information associated with one or more geographic regions via the client device 104A. The client device 104A can, via the data collection module 128, access or otherwise information associated with one or more geographic regions and stored on a server, such as 108A, or one or more data sources, such as 110A-110N. The client device 104A can, via the risk modeling engine 130 and the decision output module 132, obtain one or more scores or indexes associated with one or more geographic regions, standardize and aggregate the scores or indexes, and generate and output at least one quantitative indicator and/or a risk level indicator to the user 106A via one or more interfaces. The user 106A can, via the interfaces and the decision control module 134, make and implement one or more business operation decisions based at least in part on the evaluated political, social, and/or economic risk associated with the one or more geographic regions and corresponding to the at least one quantitative indicator and/or a risk level indicator output by the system 100.

Other system embodiments in accordance with the invention can include fewer or greater numbers of components and may incorporate some or all of the functionality described with respect to the system components shown in FIG. 1.

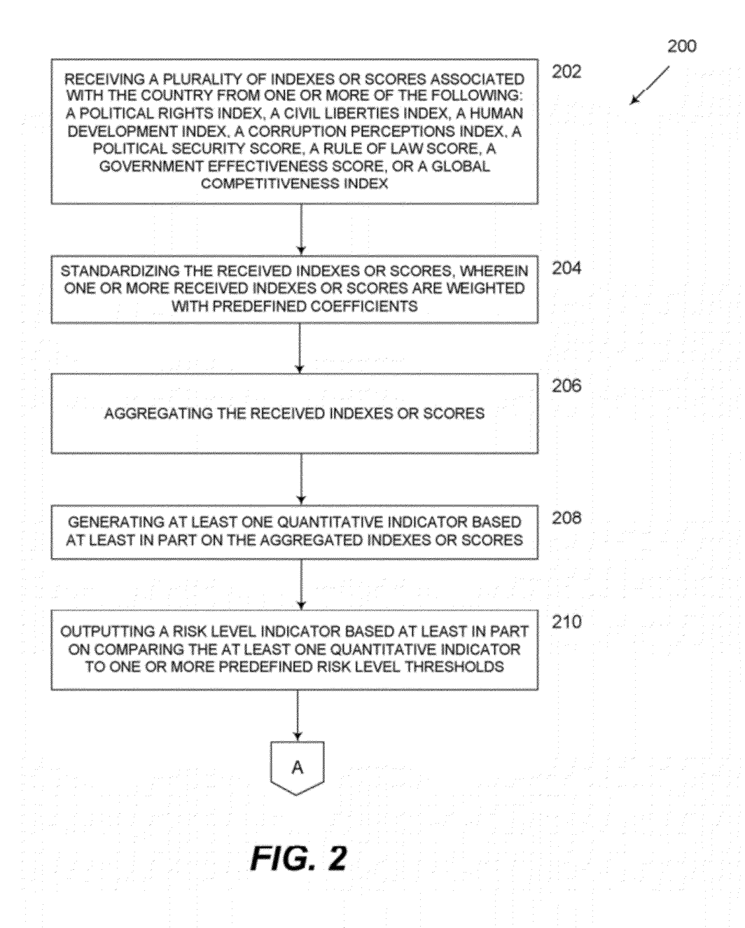

FIG. 2 illustrates an example method for evaluating political, social, and economic risk associated with a geographic region, in accordance with an embodiment of the invention. The example method 200 in FIG. 2 can be implemented by some or all of the components shown in the example political, social, and economic risk modeling and control system 100 of FIG. 1 in accordance with an example embodiment of the invention. A fewer or greater number of elements than shown can be performed, and the elements may be performed in a different order than the example described below, in accordance with embodiments of the invention.

In one aspect of an embodiment, some or all of the elements of method 200 can performed by one or more computer processors, such as 124 or 126 in FIG. 1.

The method 200 begins at block 202, in which a plurality of indexes or scores associated with the geographic region is received from one or more of the following: a political rights index, a civil liberties index, a human development index, a corruption perceptions index, a political security score, a rule of law score, a government effectiveness score, or a global competitiveness index. In the embodiment shown in FIG. 2, at least one data collection module, such as 128 or 140 in FIG. 1, associated with either or both a client device, such as 104A, or host server, such as 108A, can receive a plurality of indexes or scores associated with the geographic region from one or more of the following: a political rights index, a civil liberties index, a human development index, a corruption perceptions index, a political security score, a rule of law score, a government effectiveness score, or a global competitiveness index. At least one data collection module, such as 128, can obtain or otherwise receive the plurality of indexes or scores associated with the geographic region from at least one data source, such as 110A, via a network, such as 102. For example, any number of the indexes or scores can be obtained or otherwise received from organizations and entities, such as Freedom House, Transparency International, the United Nations, the World Bank, the World Economic Forum, and any publicly available and/or authoritative source.

Block 202 is followed by block 204, in which the received indexes or scores are standardized, wherein one or more received indexes or scores are weighted with predefined coefficients. In the embodiment shown in FIG. 2, at least one data collection module, such as 128 or 140 in FIG. 1, associated with either or both a client device, such as 104A, or host server, such as 108A, can standardize the received indexes or scores, and weight one or more of the received indexes or scores with predefined coefficients. By standardizing the received indexes or scores, at least one data collection module, such as 128, can normalize the indexes or scores to make the indexes or scores consistent with each other and relevant to any additional data received or otherwise obtained by the collection module 128. One or more predefined coefficients can be operable to weight or otherwise modify some of all of the received indexes or scores. In certain instances, a received index or score may be converted to a numerical score, and standardized or otherwise weighted with a predefined coefficient to accord with other received indexes or scores.

In one aspect of an embodiment, a quantitative approach can be used to standardize received indexes or scores. For example, one or more predefined coefficients can be selected based at least in part on a comparison with at least one risk index. Using a sample of one or more countries and a corresponding output from the at least one risk index for each of the sample countries, one or more predefined coefficients can be selected to weight some or all of the received indexes or scores, and a relatively high or close correlation with the outputs across the sample countries using the at least one risk index can be facilitated.

In one aspect of an embodiment, a qualitative approach can be used to standardize received indexes or scores. For example, one or more predefined coefficients can be selected by a nominal group process. Using one or more experts implementing a nominal group process, the experts can select one or more predefined coefficients to weight some or all of the received indexes or scores.

In one aspect of an embodiment, a combined quantitative and qualitative approach can be used to standardize received indexes or scores. For example, one or more predefined coefficients selected from a quantitative approach and one or more corresponding predefined coefficients selected from a qualitative approach can be averaged together to obtain one or more predefined coefficients to weight some or all of the received indexes or scores.

Block 204 is followed by block 206, in which the received indexes or scores are aggregated. In the embodiment shown in FIG. 2, at least one data collection module, such as 128 or 140 in FIG. 1, associated with either or both a client device, such as 104A, or host server, such as 108A, can aggregate the received indexes or scores. For example, at least one data collection module, such as 128, can implement a principal component analysis on some or all of the received indexes or scores, thereby facilitating an aggregation of the received indexes or scores. Other types of analysis or transformation can be implemented on some or all of the received indexes or scores to aggregate the received indexes or scores.

Block 206 is followed by block 208, in which at least one quantitative indicator is generated based at least in part on the aggregated indexes or scores. In the embodiment shown in FIG. 2, at least one risk modeling engine, such as 130 or 142 in FIG. 1, associated with either or both a client device, such as 104A, or host server, such as 108A, can generate at least one quantitative indicator based at least in part on the aggregated indexes or scores. For example, at least one risk modeling engine, such as 130, can generate at least one quantitative indicator, such as a numerical risk score, based at least in part on the aggregated indexes or scores. In certain embodiments, a numerical risk score can be a score between 1 and 100.

In one aspect of an embodiment, the method can further include receiving historical data associated with the geographic region; and adjusting the received indexes or scores or the at least one quantitative indicator based at least in part on the received historical data.

Block 208 is followed by block 210, in which a risk level indicator is output based at least in part on comparing the at least one quantitative indicator to one or more predefined risk level thresholds. In the embodiment shown in FIG. 2, at least one risk modeling engine, such as 130 or 142 in FIG. 1, associated with either or both a client device, such as 104A, or host server, such as 108A, can output a risk level indicator based at least in part on comparing the at least one quantitative indicator to one or more predefined risk level thresholds. For example, at least one risk modeling engine, such as 130, can output a risk level indicator, such as one of five levels of relative risk, based at least in part on comparing a numerical risk score to a set of five ranges of risk scores. In this example, five risk level indicators such as Very Low (VL), Low (L), Medium (M), High (H), and Critical (CR), may correspond with five ranges of numerical risk scores such as 0-20, 21-40, 41-60, 61-80, and 81-100. Thus, a numerical risk score of 96 can correspond with a risk level indicator of “Critical (CR).”

In one aspect of an embodiment, the method can include generating a risk trend for a plurality of predefined times based at least in part on the aggregated indexes or scores; and generating one or more qualitative indicators or risk level indicators for the plurality of predefined times.

In one aspect of an embodiment, the method can include outputting a confidence level based at least in part on the plurality of indexes or scores for the geographic region, and further based at least in part on historical data associated with the geographic region.

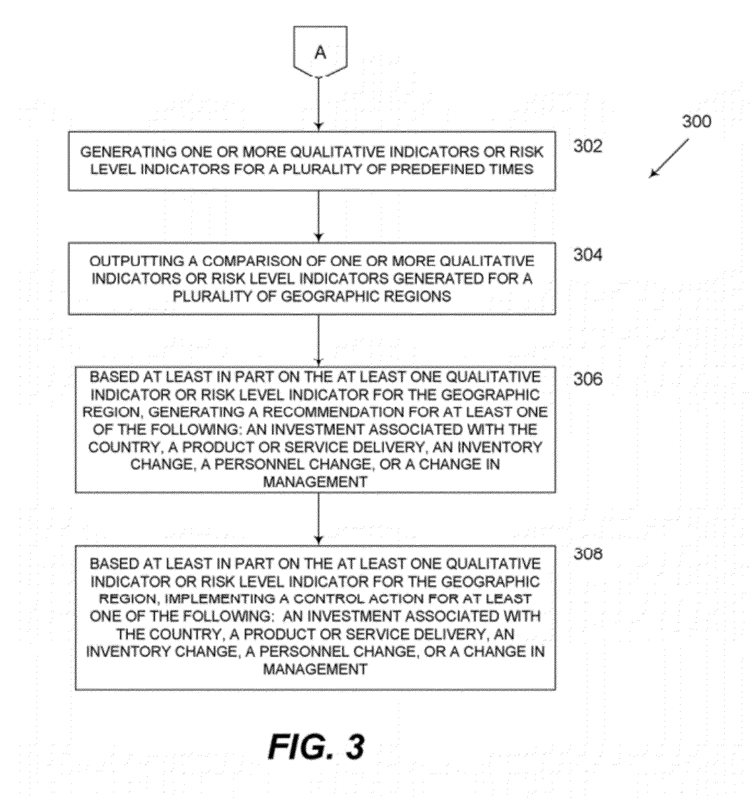

After block 210, the method 200 may end, or in certain embodiments, may continue by way of following control block A to block 302 in FIG. 3.

FIG. 3 illustrates elements for an example method for evaluating political, social, and economic risk associated with a geographic region, in accordance with an embodiment of the invention. The example method 300 in FIG. 3 can be implemented by some or all of the components shown in the example political, social, and economic risk modeling and control system 100 of FIG. 1 in accordance with an example embodiment of the invention. A fewer or greater number of elements than shown can be performed, and the elements may be performed in a different order than the example described below, in accordance with embodiments of the invention.

In one aspect of an embodiment, some or all of the elements of method 300 can performed by one or more computer processors, such as 124 or 126 in FIG. 1.

In block 302, one or more qualitative indicators or risk level indicators are generated for a plurality of predefined times. In the embodiment shown in FIG. 3, at least one risk modeling engine, such as 130 or 142 in FIG. 1, associated with either or both a client device, such as 104A, or host server, such as 108A, can generate one or more qualitative indicators or risk level indicators for a plurality of predefined times. For example, at least one risk modeling engine, such as 130, can generate one or more qualitative indicators or risk level indicators, such as one of five levels of relative risk, for a plurality of predefined times, such as a period of three years. In this example, one or more qualitative indicators or risk level indicators, such as Very Low (VL), Low (L), Medium (M), High (H), and Critical (CR), can be generated for a plurality of predefined times, such as the current year and the two subsequent years. Thus, a qualitative indicator or risk level indicator of “Critical (CR)” can be generated for the current year, and respective qualitative indicators or risk level indicators of “High (H)” and “Critical (CR)” can be generated for two subsequent years.

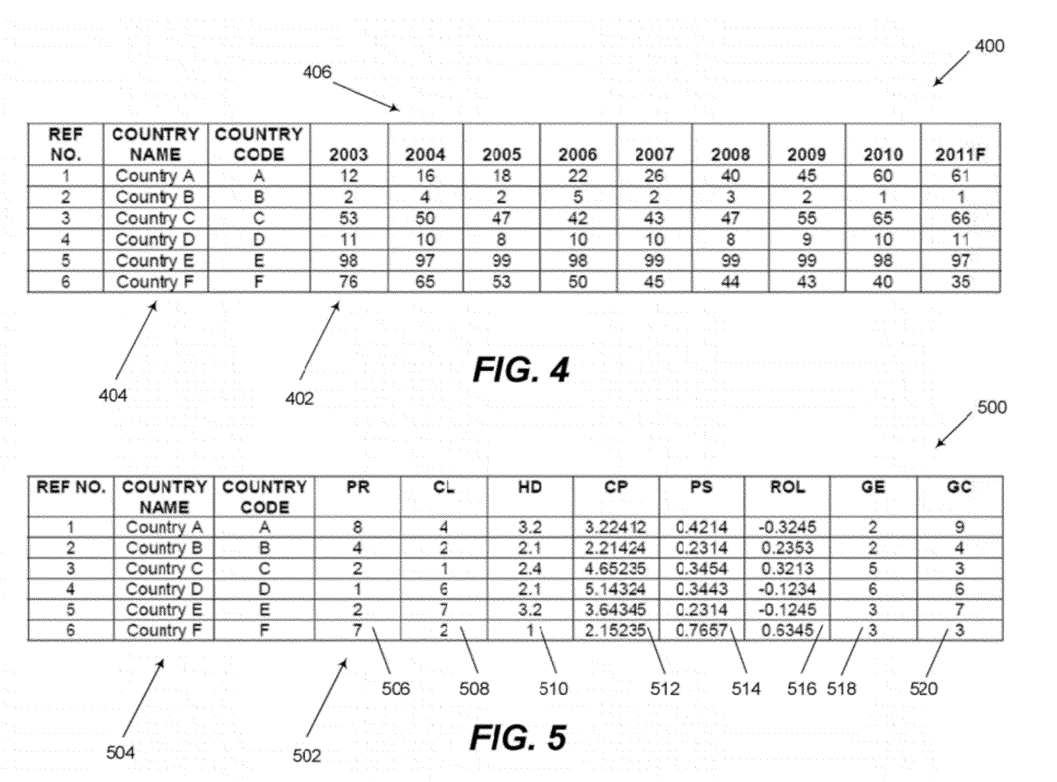

Block 302 is followed by block 304, in which a comparison is output of one or more qualitative indicators or risk level indicators generated for a plurality of geographic regions. In the embodiment shown in FIG. 3, at least one decision output module, such as 132 or 144 in FIG. 1, associated with either or both a client device, such as 104A, or host server, such as 108A, can output a comparison of one or more qualitative indicators or risk level indicators generated for a plurality of geographic regions. For example, at least one decision output module, such as 132, can output a comparison of one or more qualitative indicators or risk level indicators generated for a plurality of geographic regions. In this example, one or more qualitative indicators or risk level indicators, such as Very Low (VL), Low (L), Medium (M), High (H), and Critical (CR), can be generated for a plurality of geographic regions, such as China, Germany, and South Africa, and a comparison of the respective qualitative indicators or risk level indicators for each geographic region can be output. In another example, respective risk level indicators can be expressed as numerical scores, such as between 0-100, and output for a comparison for each geographic region. An example output according to one embodiment is illustrated and described with respect to FIG. 4.

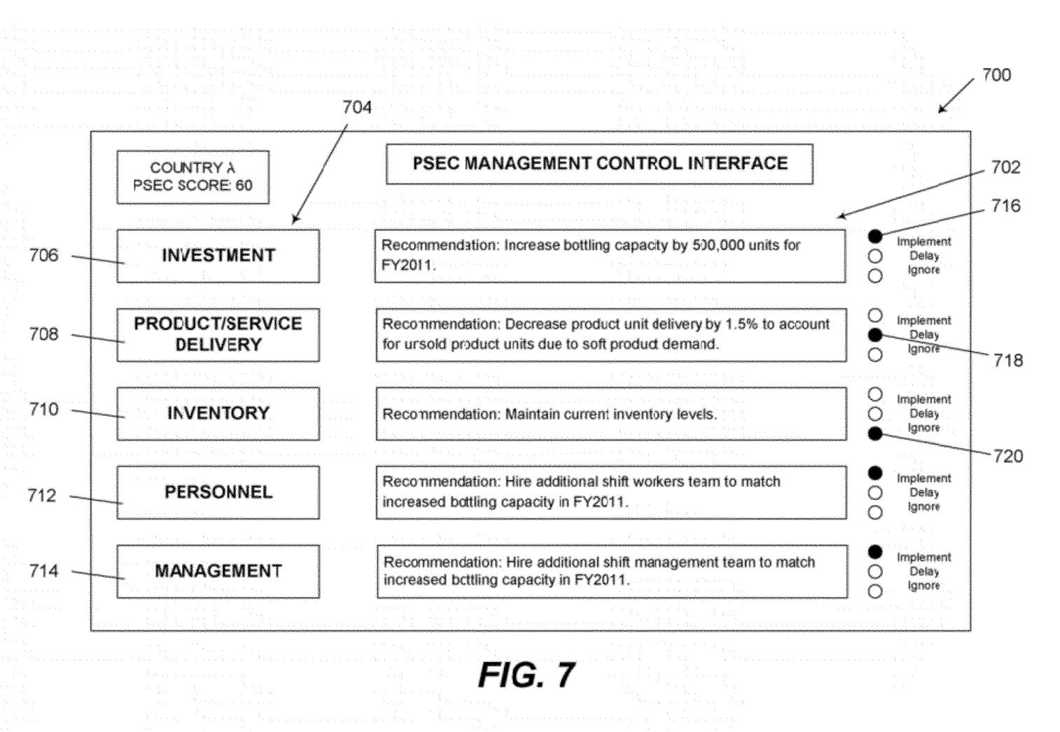

Block 304 is followed by block 306, in which a recommendation is generated based at least in part on the at least one qualitative indicator or risk level indicator for the country, wherein the recommendation is for at least one of the following: an investment associated with the geographic region, a product or service delivery, an inventory change, a personnel change, or a change in management. In the embodiment shown in FIG. 3, at least one decision control module, such as 134 or 146 in FIG. 1, associated with either or both a client device, such as 104A, or host server, such as 108A, can generate a recommendation based at least in part on the at least one qualitative indicator or risk level indicator for the country, wherein the recommendation is for at least one of the following: an investment associated with the geographic region, a product or service delivery, an inventory change, a personnel change, or a change in management. For example, at least one decision control module, such as 134, can generate a recommendation based at least in part on the at least one qualitative indicator or risk level indicator for the country, wherein the recommendation is for at least one of the following: an investment associated with the geographic region, a product or service delivery, an inventory change, a personnel change, or a change in management. In this example, a recommendation, such as increase bottling capacity, can be generated based at least in part on the at least one qualitative indicator or risk level indicator for the country. An example output is illustrated and described with respect to FIG. 7.

Block 306 is followed by block 308, in which a control action is implemented based at least in part on the at least one qualitative indicator or risk level indicator for the country, wherein the control action is for at least one of the following: an investment associated with the geographic region, a product or service delivery, an inventory change, a personnel change, or a change in management. In the embodiment shown in FIG. 3, at least one decision control module, such as 134 or 146 in FIG. 1, associated with either or both a client device, such as 104A, or host server, such as 108A, can facilitate implementing a control action based at least in part on the at least one qualitative indicator or risk level indicator for the country, wherein the control action is for at least one of the following: an investment associated with the geographic region, a product or service delivery, an inventory change, a personnel change, or a change in management. For example, at least one decision control module, such as 134, can facilitate implementing a control action based at least in part on the at least one qualitative indicator or risk level indicator for the country, wherein the recommendation is for at least one of the following: an investment associated with the geographic region, a product or service delivery, an inventory change, a personnel change, or a change in management. In this example, a control action, such as authorizing US$25 million to increase bottling capacity of 500,000 units by next year, can be implemented by way of communications between the decision control module, such as 134, and at least one organizational module and/or control engine, such as an investment control engine 112, associated with an organization, company, corporation, or other entity.

After block 308, the method 300 can end.

One skilled in the art may recognize the applicability of embodiments of the invention to other environments, contexts, and applications. One will appreciate that components of the system 100, method 200, and method 300 shown in and described with respect to FIGS. 1, 2, and 3 are provided by way of example only. Numerous other operating environments, system architectures, and methods or processes are possible. Accordingly, embodiments of the invention should not be construed as being limited to any particular operating environment, system architecture, or method or process.

Embodiments of a system, such as 100, and methods, such as 200 and 300, can facilitate evaluating political, social, and economic risk associated with a geographic region. Improvements in risk management and organizational control can be achieved by way of implementation of various embodiments of the system 100 and methods 200, 300 described herein.

FIGS. 4-7 illustrate example interfaces provided by systems and methods according to one embodiment of the invention. Other interfaces can be provided by other system and method embodiments of the invention. Various elements of the interfaces shown can be included with other elements, arranged in other orientations than shown, and may have fewer or greater numbers of elements than shown.

FIG. 4 shows an example interface 400 with a series of numerical scores for respective geographic regions. In this example, a system 100 can provide an interface 400 with one or more numerical scores 402, which correlate to respective qualitative indicators or risk level indicators generated by at least one risk modeling engine, such as 130 in FIG. 1. Corresponding geographic regions, such as countries 404, can be displayed in alphabetical order and may have an associated country code for convenience in reviewing and analyzing the associated data. Furthermore, each numerical score 402 can be associated with a predefined time 406, such as a past, current, or future year. In this example, numerical scores may exist for any number of countries over a period of time beginning in 2003 up to the present year, and may exist for two subsequent years.

FIG. 5 shows an example interface 500 with a series of indexes or scores for respective geographic regions. In this example, a system 100 can provide an interface 500 with one or more indexes or scores 502, which correlate to respective geographic regions, and generated by at least one risk modeling engine, such as 130 in FIG. 1. The corresponding geographic regions, such as countries 504, can be displayed in alphabetical order and may have an associated country code for convenience in reviewing and analyzing the associated data. Furthermore, each index or score 502 can be displayed with one or more components of the respective index or score shown in the interface. In this example, an index or score may include a political rights index component (PR) 506, a civil liberties index component (CL) 508, a human development index component (HD) 510, a corruption perceptions index component (CP) 512, a political security score component (PS) 514, a rule of law score component (ROL) 516, a government effectiveness score component (GE) 518, and a global competitiveness score component (GC) 520. Other embodiments can include other indexes or scores, or components.

FIG. 6 shows an example interface 600 with a management tool, dashboard-type arrangement illustrating a political, social, economic composite (PSEC) risk score for a particular geographic region. In this example, a system 100 can provide an interface 600 with a current PSEC score 602 for the particular geographic region, generated by at least one risk modeling engine, such as 130 in FIG. 1. In this example, the PSEC risk score 602 can be displayed with other business or geographic region-related information including a summary description of the geographic region 604; a book value 606 of tangible assets in the geographic region, a graphical interface 608 showing the relative PSEC score 610 over a predefined period of time 612 and associated confidence level 614; a graphical interface 616 showing components of a PSEC score 602, such as a political score 618, a social score 620, and an economic score 622; a volume of product/services sold 624 in the geographic region over a predefined period of time; a gross domestic product growth chart 626 over a predefined period of time, and other configurable charts 628, 630 or menus operable for displaying business or geographic region-related information. Other interface embodiments can include other orientations and/or business or geographic region-related information.

Using the interface 600, a user can drill down to one or more other interfaces by clicking on any of the graphical interfaces and/or pull down menus. For example, a corresponding interface, similar to 500 in FIG. 5, showing the various components of a PSEC score can be viewed by clicking on certain elements of the graphical interface 614 showing components of the PSEC score 602. Other drill down interface examples can be obtained in accordance with other embodiments of the invention.

FIG. 7 illustrates an example interface with a recommendation output shown for a particular geographic region. In this example, a system 100 can provide an interface 700 with one or more recommendations 702 for a particular geographic region, generated by at least one decision control module, such as 134 in FIG. 1. The recommendations 702 can be displayed with respect to certain organizational or entity functions 704, such as investment 706, product/service delivery 708, inventory 710, personnel 712, and management 714 for convenience in reviewing and analyzing the associated recommendations. Each of the organizational or entity functions 704-714 shown can correspond with a control module or engine associated with the organization or entity, such as 112-120 in FIG. 1. As each recommendation 702 is displayed, a user can select a decision control command, such as Implement 716, Delay 718, or Ignore 720. Upon or after selection of a decision control command for some or all of the recommendations, the decision control module, such as 134, can communicate with at least one module or engine associated with the organization or entity, such as modules 112-120, to implement a suitable control action corresponding with the selected decision control command. Other embodiments can include other recommendations, organizational or entity functions, decision control commands, and interface arrangements.

In the embodiment shown in FIG. 7, the interface 700 and associated system, such as 100 in FIG. 1, can be used to facilitate a production decision, such as for a beverage company operating a concentrate plant in a particular geographic region such as “Country A.” Based on certain political, social and/or economic risks associated with Country A, the associated system, similar to 100, can determine a PSEC score for Country A, such as “60” on a scale of 0 to 100, with 0 indicative of low risk and 100 indicative of high risk. Based at least in part on the PSEC score, the system can determine one or more recommendations 702 to output with respect to various aspects of the beverage company's operations in Country A, such as production, distribution, inventory, personnel, management, and investment. Using one or more decision control commands 716-720 corresponding to some or all of the recommendations 702, a user can select and implement a suitable control action for the company's operations in Country A, such as making a production decision for the beverage company's concentrate plants in Country A or planning and implementing product distribution in one or more areas of Country A.

In one embodiment, interfaces similar to 600 and 700 in FIGS. 6 and 7 can be implemented with a system similar to 100 in FIG. 1 to facilitate investment decisions involving one or more investments in one or more geographic regions or markets. For example, a system can evaluate the relative political, social and/or economic risks associated with investing among the one or more geographic regions, and could output a comparison of the risks between the geographic regions. Based on the comparison, the system could generate one or more investment recommendations, such as which geographic region or market to invest in, or the relative amount of capital to invest in one or more geographic regions or markets. One may appreciate that in certain embodiments, geographic regions or markets can represent entities or companies, and certain system and interface embodiments can be adapted to evaluate political, social and/or economic risks associated with entities or companies.

Embodiments of the invention are described above with reference to block diagrams and flowchart illustrations of systems, methods, apparatuses and computer program products. It will be understood that some or all of the blocks of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing the functions specified in the flowchart block or blocks.

Accordingly, blocks of the block diagrams and flowchart illustrations may support combinations of means for performing the specified functions, combinations of elements or steps for performing the specified functions, and program instruction means for performing the specified functions. It will also be understood that some or all of the blocks of the block diagrams and flowchart illustrations, and combinations of blocks in the block diagrams and flowchart illustrations, can be implemented by special purpose hardware-based computer systems that perform the specified functions, elements or steps, or combinations of special purpose hardware and computer instructions.

Additionally, it is to be recognized that, while the invention has been described above in terms of one or more preferred embodiments, it is not limited thereto. Various features and aspects of the above described invention may be used individually or jointly. Although the invention has been described in the context of its implementation in a particular environment and for particular purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every step described and illustrated need be performed. Accordingly, the claims set forth below should be construed in view of the full breadth of the invention as disclosed herein.

The claimed invention is:

1. A system for evaluating political, social, and economic risk associated with a geographic region, comprising:
a computer processor operable to execute computer readable instructions embodied in a data collection module and a risk modeling engine;
an output device;
the data collection module operable to:
receive a plurality of indexes or scores associated with the geographic region from one or more of the following: a political rights index, a civil liberties index, a human development index, a corruption perceptions index, a political security score, a rule of law score, a government effectiveness score, or a global competitiveness index;
standardize the received indexes or scores, wherein one or more received indexes or scores are weighted with predefined coefficients; and
aggregate the received indexes or scores; and
the risk modeling engine operable to:
generate at least one quantitative indicator based at least in part on the aggregated indexes or scores; and
output a risk level indicator to the output device based at least in part on comparing the at least one quantitative indicator to one or more predefined risk level thresholds.

2. The system of claim 1, wherein the data collection module is further operable to:
receive historical data associated with the geographic region; and
adjust the received indexes or scores or the at least one quantitative indicator based at least in part on the received historical data.

3. The system of claim 1, wherein the risk modeling engine is further operable to:
generate a risk trend for a plurality of predefined times based at least in part on the aggregated indexes or scores, the system further comprising:
a decision output module operable to:
generate one or more qualitative indicators or risk level indicators for the plurality of predefined times.

4. The system of claim 1, wherein the risk modeling engine is further operable to:
output a confidence level based at least in part on the plurality of indexes or scores for the geographic region, and further based at least in part on historical data associated with the geographic region.

5. The system of claim 1, further comprising:
a decision output module operable to:
output a comparison to the output device of one or more qualitative indicators or risk level indicators generated for a plurality of geographic regions.

6. The system of claim 1, further comprising:
a decision control module operable to:
based at least in part on the at least one qualitative indicator or risk level indicator for the geographic region, generate a recommendation for at least one of the following: an investment associated with the geographic region, a product or service delivery associated with the geographic region, an inventory change associated with the geographic region, a personnel change associated with the geographic region, or a change in management associated with the geographic region.

7. The system of claim 1, further comprising:
a decision control module operable to:
based at least in part on the at least one qualitative indicator or risk level indicator for the geographic region, implement a control action for at least one of the following: an investment associated with the geographic region, a product or service delivery associated with the geographic region, an inventory change associated with the geographic region, a personnel change associated with the geographic region, or a change in management associated with the geographic region.

8. The system of claim 1, wherein some or all of the received indexes or scores are subjected to principal component analysis.

9. The system of claim 1, wherein the risk modeling engine is further operable to: output an indication of a type of risk that influences the at least one quantitative indicator.

10. A computer program product, comprising a computer readable medium having computer readable program code, the computer readable program operable to be executed to implement a method for evaluating political, social, and economic risk associated with a geographic region, the method comprising:
providing a system, wherein the system comprises software modules, wherein the software modules comprise a data collection module and a risk modeling engine;
receiving, by the data collection module, a plurality of indexes or scores associated with the geographic region from one or more of the following: a political rights index, a civil liberties index, a human development index, a corruption perceptions index, a political security score, a rule of law score, a government effectiveness score, or a global competitiveness index;
standardizing, by the data collection module, the received indexes or scores, wherein one or more received indexes or scores are weighted with predefined coefficients;
aggregating, by the data collection module, the received indexes or scores;
generating, by the risk modeling engine, at least one quantitative indicator based at least in part on the aggregated indexes or scores; and
outputting, by the risk modeling engine, a risk level indicator based at least in part on comparing the at least one quantitative indicator to one or more predefined risk level thresholds.

11. The computer program product of claim 10, wherein the method further comprises:
receiving, by the data collection module, historical data associated with the geographic region; and
adjusting, by the data collection module, the received indexes or scores, or by the risk modeling engine, the at least one quantitative indicator based at least in part on the received historical data.

12. The computer program product of claim 10, wherein the method further comprises:
generating, by the risk modeling engine, a risk trend for a plurality of predefined times based at least in part on the aggregated indexes or scores, and wherein the software modules further comprise a decision output module, and the method further comprises:
generating, by the decision output module, one or more qualitative indicators or risk level indicators for the plurality of predefined times.

13. The computer program product of claim 10, wherein the method further comprises:
outputting, by the risk modeling engine, a confidence level based at least in part on the plurality of indexes or scores for the geographic region, and further based at least in part on historical data associated with the geographic region.

14. The computer program product of claim 10, wherein the software modules further comprise a decision output module, and the method further comprises:
outputting, by the decision output module, a comparison of one or more qualitative indicators or risk level indicators generated for a plurality of geographic regions.

15. The computer program product of claim 10, wherein the software modules further comprise a decision control module, and the method further comprises:
based at least in part on the at least one qualitative indicator or risk level indicator for the country, generating, by the decision control module, a recommendation for at least one of the following: an investment associated with the geographic region, a product or service delivery associated with the geographic region, an inventory change associated with the geographic region, a personnel change associated with the geographic region, or a change in management associated with the geographic region.

16. The computer program product of claim 10, wherein the software modules further comprise a decision control module, and the method further comprises:
based at least in part on the at least one qualitative indicator or risk level indicator for the country, implementing, by the decision control module, a control action for at least one of the following: an investment associated with the geographic region, a product or service delivery associated with the geographic region, an inventory change associated with the geographic region, a personnel change associated with the geographic region, or a change in management associated with the geographic region.

17. The computer program product of claim 10, wherein some or all of the received indexes or scores are subjected to principal component analysis.

18. A method for evaluating political, social, and economic risk associated with a geographic region, the method comprising:
receiving a plurality of indexes or scores associated with the geographic region from one or more of the following: a political rights index, a civil liberties index, a human development index, a corruption perceptions index, a political security score, a rule of law score, a government effectiveness score, or a global competitiveness index;
standardizing the received indexes or scores, wherein one or more received indexes or scores are weighted with predefined coefficients;
aggregating the received indexes or scores;
generating at least one quantitative indicator based at least in part on the aggregated indexes or scores; and
outputting a risk level indicator based at least in part on comparing the at least one quantitative indicator to one or more predefined risk level thresholds,
wherein the above elements are performed by one or more computer processors.

19. The method of claim 18, further comprising:
receiving historical data associated with the geographic region; and
adjusting the received indexes or scores or the at least one quantitative indicator based at least in part on the received historical data.

20. The method of claim 18, further comprising:
generating a risk trend for a plurality of predefined times based at least in part on the aggregated indexes or scores; and
generating one or more qualitative indicators or risk level indicators for the plurality of predefined times.

21. The method of claim 18, further comprising:
outputting a confidence level based at least in part on the plurality of indexes or scores for the geographic region, and further based at least in part on historical data associated with the geographic region.

22. The method of claim 18, further comprising:
outputting a comparison of one or more qualitative indicators or risk level indicators generated for a plurality of geographic regions.

23. The method of claim 18, further comprising:
based at least in part on the at least one qualitative indicator or risk level indicator for the country, generating a recommendation for at least one of the following: an investment associated with the geographic region, a product or service delivery, an inventory change, a personnel change, or a change in management.

24. The method of claim 18, further comprising:
based at least in part on the at least one qualitative indicator or risk level indicator for the country, implementing a control action for at least one of the following: an investment associated with the geographic region, a product or service delivery, an inventory change, a personnel change, or a change in management.

25. The method of claim 18, wherein some or all of the received indexes or scores are subjected to principal component analysis.
